(19) United States
(12) Patent Application Publication
(10) Pub. No.: US 2006/0048210 A1
(43) Pub. Date: Mar. 2, 2006

(54) System and method for policy enforcement in structured electronic messages

(76) Inventors: Eric Arnold Hildre, Lorton, VA (US); Theodore Delano Putnam, Williamsburg, VA (US)

Correspondence Address: GEORGE A. WILLINGHAN, III;AUGUST LAW GROUP, LLC, P.O. BOX 19080, BALTIMORE, MD, 21284-9080, US

(21) Appl. No.: 10/931,876

(22) Filed: Sep. 1, 2004

(51) Int. Cl. H04L 9/00

(52) U.S. Cl. 726/1

(57) ABSTRACT

The present invention is directed a validation service, for example a digital certificate validation service (CVS), that facilitates the application of user-defined policies to structured electronic messages, for example E-mails, and the implementation of corresponding business rules based on user, system, device or electronic message attributes. The present invention provides an easily scalable, extensible and reliable solution to enforcing policies in electronic communications. The service includes a method for policy enforcement in electronic messages that includes identifying one or more policies to be applied to an electronic message send from a first end entity to a second end entity and identifying at least one business rule to be applied to the electronic message. The electronic message is evaluated for compliance with the identified policy or policies, and the electronic message is routed in accordance with the policy evaluation and the identified business rules. The service is also includes a system for policy enforcement containing a single centralized validation server capable of intercepting the electronic messages and of evaluating those messages for compliance with pre-defined policies and business rules. The extensible policy verification server also includes a policy engine, a policy builder capable, a policy engine definition file to store a complete definition of the policy engine, a messaging queue and a scheduler.

### FIELD OF THE INVENTION

The present invention is directed to systems and methods for providing policy enforcement for electronic communications and in particular to messages employing Public Key Infrastructure technology.

### BACKGROUND OF THE INVENTION

Organizations, for example large commercial enterprises and governments, have a fundamental need to protect and secure sensitive and proprietary information. Typically, organizations employ a combination of policies, procedures and technologies to secure these assets. However, experience and history have proven that unless policies and procedures are systematically applied, they are particularly difficult to enforce.

Such enforcement difficulties exist in electronic messaging systems such as E-mail. Electronic messages present two significant risks. First, electronic messages are often transmitted over public, unsecured or un-trusted networks, creating a significant risk to message authenticity, i.e. determining if the message is real, message integrity, i.e. determining if someone intercepted and modified the message, and message confidentiality, i.e. determining if an unauthorized party read the contents of the message. Second, recipients of electronic messages can fail to apply proper security procedures when reading or opening messages, for example opening mail from unknown senders or executing attachments. Consequently, organizations are employing various techniques to improve the security of the information contained in electronic messages. One of these techniques is Public Key Encryption.

Public Key Encryption, also referred to as asymmetric encryption, provides for the secure transfer of messages across networks and in particular unsecured networks. In general, Public Key Encryption uses matched pairs of public keys and private keys. The public key is an encryption key, and the private key is the associated decryption key. Each user broadcasts its public key across a network and maintains the associated private key in secret. Each key is constructed such that one key cannot be derived from the other.

In order to send a secure message to a recipient, a sender obtains the public key for the recipient, which has been broadcast across the network by the recipient. Using the public key, the sender encodes the message and sends the encoded message to the recipient. The recipient receives the encoded message, and using its associated private key, which only the recipient knows, the recipient decodes the message.

Public Key Encryption is also useful in providing signed electronic messages that are dependent on both the signature associated with the message and the content of the message. A user receiving a signed message can be assured that the message has not been tampered with and can also be assured that the message is authentic, i.e. that the message originated from the indicated sender. Signed messages cannot be modified by recipients, and the attached signatures can not be used by recipients as signatures for other messages. In addition, signatures prevent senders from disclaiming sending the message at a later time. Therefore, Public Key Encryption is used to provide for tamper detection, authentication and non-repudiation of messages exchange between two users across the network.

In order to send a secure, signed message, the sender uses its own private key to generate a signed message and then uses the recipient's public key to encode the signed message. The sender then sends the encoded, signed message to the recipient. The recipient, upon receipt of the encoded, signed message, initially uses its own private key to decode the message. Then, the recipient uses the sender's public key to decode the signed message. Authentication and non-repudiation are provided since only the sender could have signed the message using its private key and the recipient had to use the sender's public key to decode the signed message. The recipient cannot modify the signed document, because once the signed document from the sender is decoded, the recipient would need to know the sender's private key to sign the document again after modification.

Security and integrity throughout a system using Public Key Encryption depends on the cryptographic security and integrity of the public and private keys. Public Key Infrastructure (PKI) refers to a system by which public keys can be managed on a secure basis for use by widely distributed users or systems. PKI supports digital signatures and other public key enabled security services.

PKI enables users of a basically non-secure public network, for example the Internet, to securely and privately exchange data or electronic messages through the use of the public and private key pairs by providing for digital certificates that can identify a user or group of users and for directory services that can store and, when necessary, revoke the certificates. A digital certificate is an electronic identification card that establishes each user's credentials when exchanging messages or other data across the network. Generally contained within each digital certificate is the associated user's name, a serial number, expiration dates, a copy of the user's public key and the digital signature of the certificate-issuing authority so that a recipient can verify that the certificate is real. Digital certificates are issued and verified by a certification authority (CA) and can be kept in registries so that authenticating users can look up other users' public keys.

The CA is an authority in a network that issues and manages security credentials and public keys for message encryption and other purposes. As part of the PKI, the CA checks with a registration authority (RA) to verify information provided by the requester of a digital certificate. If the RA verifies the requestor's information, the CA can then issue a certificate. A certificate management system is used to guide the verification of information and issuance of certificates. A digital certificate contains the digital signature of the CA so that anyone can verify that the certificate is authentic.

In PKI, the public and private keys are created simultaneously by the CA using the same algorithm. The private key is given only to the requesting user, and the public key is made publicly available as part of a digital certificate contained in a public directory that all users can access. The private key is never shared with anyone or sent across the network. There is currently no single, world-wide CA. But a plurality of local or regional CA's that use cross-certification to permit one CA to vouch for the authenticity of another CA.

Therefore, a PKI is a collection of CA's arranged in a hierarchic structure. A root or top-level CA certifies lower level CA's which then certify even lower level CA's or end users. Interoperability and mutual recognition among these CA's are important aspects of the operation of the PKI. Also, rules need to be enforced among the CA's and users to ensure the integrity of the PKI system and to avoid abuse or errors in certification.

PKI is a dynamic system where the validity of each certificate changes over time due to factors including a change in the status of users and a change in the certificate validation policies. These changes need to be managed by all of the CA's and to be distributed to increasing numbers of concurrent users. Current PKI systems do not provide adequate scalability and reliability for certificate validation. These systems do not readily scale to an increasing number of users or certificates and do not accommodate a large number of applications. In addition, current systems do not provide sufficient flexibility to permit efficient utilization of system resources. For example, not all electronic communications may be of a sensitive nature; however, current systems require that all electronic messages have to be verified. Therefore, if system capacity is insufficient to provide for certificate validation for the volume of messages, then either the transmission will fail or none of the electronic messages will be verified. In addition, if a timely certificate verification list (CRL) is unavailable, the electronic communication will simply fail. These CRL's are large and growing and present a large demand on system bandwidth.

Therefore, a system is needed that can provide for continuous and reliable verification of digital certificates and other defined policies and rules given changing conditions. Suitable systems would be able to handle large numbers of users simultaneously and be scalable to growing numbers of users. In addition, the system would provide for easy user-defined modification of certificate validation policies and would be suitable for use in high security systems such as e-commerce and tactical applications. The system will accommodate the current certificate validation demands within available bandwidth and will be transparent to the end-users.

### SUMMARY OF THE INVENTION

The present invention is directed to a policy verification service, for example an extensible policy verification service (XPVS), that facilitates the application of user-defined policies to structured electronic messages, for example E-mails, and the implementation of corresponding business rules based on user, system, device or electronic message attributes. The present invention provides an easily scalable, extensible and reliable solution to enforcing policies in electronic communications.

The service includes a method for policy enforcement in electronic messages that includes identifying one or more policies to be applied to an electronic message sent from a first end entity or user to a second end entity or user and identifying at least one business rule to be applied to the electronic message. The electronic message is evaluated for applicability with the identified policy or policies, and the electronic message is routed in accordance with the policy evaluation and the identified business rules.

In order to identify each policy, one or more decision points are identified. The decision points can be chosen from a list of pre-defined decision points or can be inputted by the user. Each decision point defines a process used to evaluate a quality of the electronic message to be evaluated. The decision points include verifying that the electronic message is signed, verifying that the electronic message is signed using a signature certificate issued by a trusted certificate authority, verifying that the first end entity owns the signature certificate, verifying that the signature certificate has not expired, verifying the signature certificate by verifying a certificate authority signature, verifying that a certificate revocation list to be used to verify the signature certificate is available and updated, verifying that the electronic message has not been modified after being sent by the first end entity, verifying a domain associated with the first end entity, verifying a domain associated with the second end entity, verifying that the electronic message is in the proper format and combinations thereof.

Associated with each identified decision point is one or more actions to be taken based upon the evaluation of the electronic message. Examples of these decision point actions include sending the electronic message to the second end entity, routing the electronic message to a third party, rejecting the electronic message, modifying the electronic message, notifying the first end entity regarding results of the policy evaluation, notifying second end entities regarding the results of the policy evaluation, notifying the third party regarding the results of the policy evaluation, returning the electronic message to the first end entity and combinations thereof. Therefore, each identified policy is a collection of one or more pairs of decision points and decision point actions.

Policies and business rules can be applied uniformly across all electronic messages or can be tailored to electronic message-based factors that can vary from message to message. These factors can be taken into account during the creation of decision points, the selection of decision points, the creation of decision point actions, the association of decision point actions with the decision points, the creation of each policy and the selection of one policy from among a plurality of identified policies. Message-based factors can also be taken into account when identifying or applying business rules. Assistance in creating policies based upon message content can be provided by creating one or more decision point selection templates to assist in selecting decision points based upon electronic message content. The desired decision points are then selected based upon one of the templates.

In order to enforce the identified policies and business rules in electronic messages, each electronic message is evaluated against the associated policies. The messages are then handled or routed in accordance with these evaluations and any identified business rules. Examples of routing procedures include sending the electronic message to the second end entity, routing the electronic message to a third party, rejecting the electronic message, modifying the electronic message, notifying the first end entity regarding results of the policy evaluation, notifying second end entities regarding the results of the policy evaluation, notifying the third party regarding the results of the policy evaluation, returning the electronic message to the first end entity and combinations thereof.

The service also includes a system for certificate validation of electronic messages exchanged among a plurality of users in communication with each other across one or more networks. The system includes at least one extensible policy verification server capable of evaluating the PKI certificates within the electronic messages and of evaluating those messages for compliance with pre-defined policies and business rules. The extensible policy verification server also includes a policy engine capable of enforcing the policies and business rules, a policy builder capable of building the policy engine and a policy engine definition file to store a complete definition of the policy engine. The policy engine contains a plurality of simple policy nodes that each defines a specific policy test and resulting action and a plurality of macro policy nodes that define combinations of the simple policy nodes.

Also included in the extensible policy verification server is a messaging queue to intercept incoming and outgoing electronic messages for evaluation by the policy engine and a scheduler to schedule the evaluation of electronic messages in the messaging queue by the policy engine. In order to handle PKI certificate validation, the extensible policy verification server is in communication with one or more Certificate Revocation List Distribution Points from which it can acquire certificate revocation lists (CRL). The extensible policy verification server is capable of using multiple certificate validation techniques to validate certificates.

### BRIEF DESCRIPTION OF THE DRAWINGS

FIG. 1 is a schematic representation of a networked application of a system in accordance with the present invention;

FIG. 2 is a schematic representation of an embodiment of a system in accordance with the present invention;

FIG. 3 is a flow chart illustrating an embodiment of a method for policy enforcement in accordance with the present invention;

FIG. 4 is a flow chart illustrating an embodiment for the identification of a policy;

FIG. 5 is a flow chart illustrating another embodiment of a method for policy enforcement in accordance with the present invention;

FIG. 6 is a flow chart illustrating an embodiment of sending a signed, encoded message for validation in accordance with the present invention; and

FIG. 7 is a flow chart illustrating an embodiment of policy enforcement and routing in accordance with the present invention.

### DETAILED DESCRIPTION

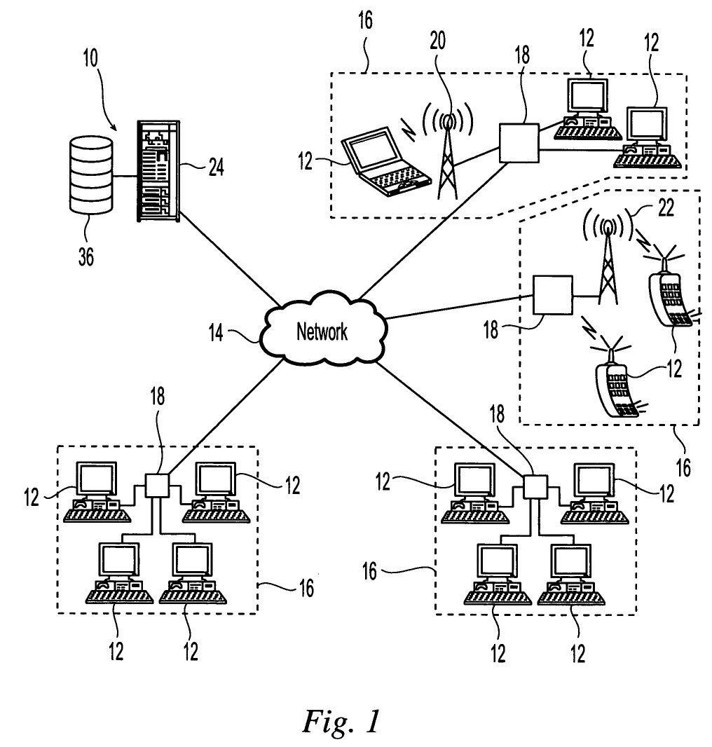

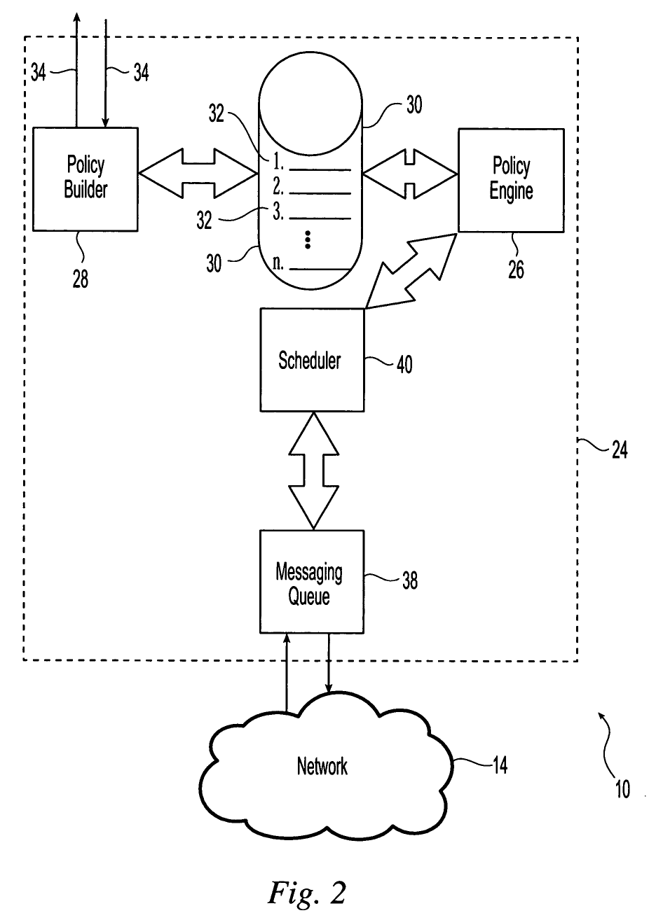

Referring initially to FIGS. 1 and 2, the present invention is directed to a system 10 for enforcing policies, for example security or encryption polices, and business rules in electronic messages sent across secure and un-secure networks. For example, the system 10 is used to provide signature certificate validation of electronic messages. In one embodiment as illustrated a plurality of end entities or users 12 are in communication with each other across one or more networks 14. As used herein, an end entity refers to a person or device that is capable of sending and receiving electronic messages across the network 14.

The electronic messages can be text-based messages and can include audio and video components. Suitable formats for the electronic messages include E-mail, with and without attachments, instant messaging and other text-based messaging systems. The electronic messages can be produced using any commercially available electronic messaging software and with any operating system or hardware platform. In addition, the system and method in accordance with the present invention can be integrated into customizable or proprietary electronic messaging systems and can be used with tactical applications. Suitable networks 14 over which the end entities 12 communicate include wide area networks such as the Internet or World Wide Web, local area networks (LAN), secure area networks, virtual private networks (VPN), public switched telephone networks (PSTN) and combinations thereof.

In one embodiment, all of the end entities 12 can be located in the same network domain. Alternatively, the end entities 12 are grouped together in different domains 16. In addition, each end entity 12 can be in communication with a local server 18, for example an internet service provider (ISP). In one embodiment, each local server 18 is associated with a particular domain 16 and facilitates the sending and receiving of electronic messages for end entities 12 within that domain 16. The end entities 12 can be in communication with the local server 18 and network 14 through standard wire-line connections such as telephone lines, digital subscriber lines, co-axial cable lines, T-1 lines and fiber-optic lines. In addition, the end entities 12 can be in communication with the local servers 18 and network 14 through local area wireless connections 20 utilizing Bluetooth and 802.11-type technologies and through wide area wireless connections 22 utilizing cellular transmitting technologies, for example cellular phones and Blackberry® systems and satellite communication and transmission systems. The system and method in accordance with the present invention can identify the type of communication connection associated with each end entity and can differentiate among these various communications when evaluating electronic messages against policies and business rules.

The system 10 includes at least one certificate verification server 24. Any certificate verification server 24 capable of intercepting the electronic messages being exchanged among the end entities 12 is suitable to be used with the system 10. In one embodiment, the certificate verification server 24 is capable of employing a variety of techniques to validate a certificate associated with an electronic message and of using one or more of these techniques at the same time for a certificate validation operation. Suitable certificate validation techniques include, but are not limited to, Certificate Revocation Lists as defined by RFC 3280, Online Certificate Status Protocol (OCSP) as defined by RFC 2560 and Simple Certificate Status Protocol (SCVP). Preferably, the certificate verification server comprises an extensible policy verification server 24. In one embodiment, the extensible policy verification server 24 is capable of utilizing certificate revocation lists for an extended period of time beyond the validity period or expiration of a given certificate. This extended period of time can be user-defined.

Once intercepted, the extensible policy verification server can evaluate the messages for compliance with pre-defined policies and business rules. In one embodiment, one or more of the local servers 18 also act as extensible policy verification servers. Preferably, the extensible policy verification servers 24 are one or more independent servers, that is are independent of and separate from the local servers 18. These independent servers are in communication with each end entity and with the local servers 18 across the network 14 so that the independent servers can receive and forward electronic messages among the various end entities 12. Preferably, the extensible policy verification server 24 is a single, centralized server.

In one embodiment as illustrated in FIG. 2, the extensible policy verification server 24 includes a policy engine 26 capable of enforcing the policies and business rules. The policy engine 26 contains the logic or logical arguments that constitute the policies and business rules that are used to evaluate the electronic messages. These logical arguments include simple policy nodes. Each policy node contains the logical structure for a specific decision point and the resulting decision point action. The logical arguments also include macro policy nodes. Macro policy nodes provide the logic for specifying more complex policies by combining two or more simple policy nodes. Therefore, each policy against which the electronic messages are evaluated typically contains two or more decision points paired with the resulting decision point actions. In one embodiment, the extensible policy verification server comprises a plurality of policy engines. Each policy engine is associated with one or more certification authorities containing one or more revocation lists.

In order to construct the policy engine 26, the extensible policy verification server includes a policy builder 28. The policy builder is in communication with a policy engine definition file 30 that it uses to store the policy definitions for the policy engine 26 including simple policy nodes 32, macro policy nodes and static attributes. The policy engine 26 is also in communication with the policy engine definition file 30. The policy builder 28 includes inputs and outputs 34 for accepting user-defined policies for use in building the policy engine 26. Preferably, the policies and business rules used in accordance with the present invention are constructed, expressed and stored in a human readable format, for example extensible markup language (XML), making the system and methods of the present invention easy to use and to customize. This storage can be accomplished using a graphical user interface (GUI) or by hand when creating the XML policy engine definition file.

In addition to the policy engine definition file 30, the extensible policy verification server 24 can include or can be in communication with one or more computer readable storage mediums 36, i.e. databases, that contain computer readable code for use by the policy engine 26 in evaluating the electronic messages and also for providing other operating functions of the extensible policy verification server 24. In one embodiment, the computer readable code includes thread-safe routines. The storage mediums 36 can include component libraries containing modularized components, for example dynamic link libraries (DLL) that support the policy enforcement mechanisms.

In order to facilitate the evaluation of electronic messages and in particular to provide for the verification of signature certificates, the extensible policy verification servers 24 have access to one or more certificate revocation lists (CRL's). A CRL can be obtained, for example, from a certificate authority (CA) with which the extensible policy verification server 24 is in communication across the network 14. In one embodiment, the extensible policy verification server 24 regularly obtains updated CRL's and stores the updated CRL's in the storage medium 36 for access by the server or policy engine 26. In one embodiment, the policy engine definition file 30 is contained on the storage medium 36.

The extensible policy verification server 24 also includes a messaging queue 38 to intercept incoming and outgoing electronic messages for evaluation by the policy engine and a scheduler 40 to schedule the evaluation of electronic messages in the messaging queue 38 by the policy engine 26.

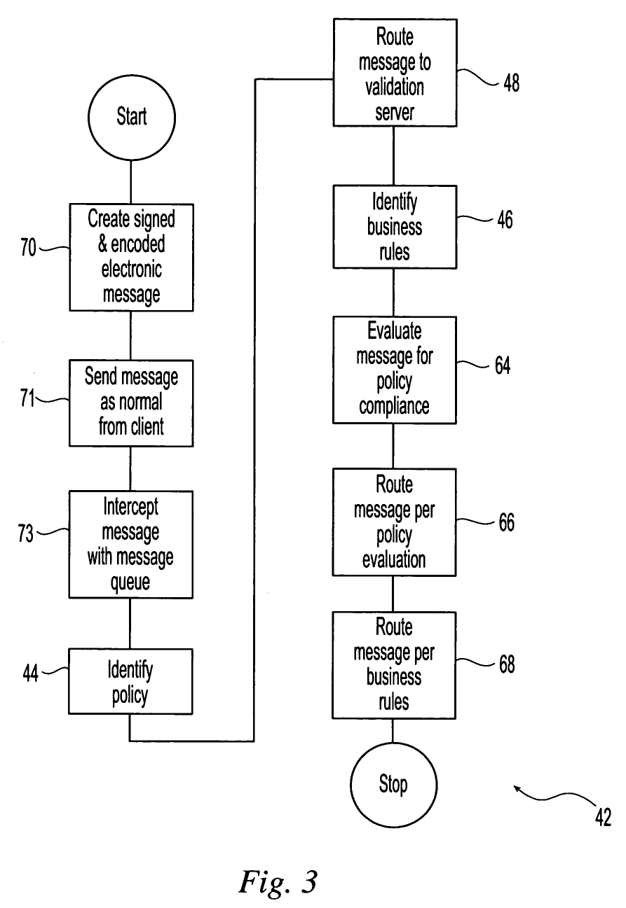

Referring to FIG. 3, the present invention is also directed to a method for evaluating the electronic messages 42 against one or more polices and business rules, including signature certificate validation. In one embodiment as illustrated, the method 42 includes identifying at least one policy 44 to be applied to an electronic message that has been sent from a first end entity to a second end entity. As used herein, the term policy refers to the logical expression of rules, either pre-defined rules, standardized rules or user-defined rules, governing the handling and routing of electronic messages to and from the end entities 12. These rules can govern the identity of users having permission to send or to receive electronic messages. In addition, the rules contain protocols for exchanging electronic messages between different domains and for the use of electronic signatures and encryption. Other rules apply to the actual content of the electronic messages and the control of users having access to that content. An example of a rule contained within the policies is that all electronic messages sent between two users have to be encrypted and signed. An example of another rule is that messages going to a particular domain only need to be signed if they discuss a particular topic, but all messages need to be encrypted. Therefore, as is shown in these examples, rules can vary in scope based on various electronic message-based factors including the identity of the senders, source domains and topics.

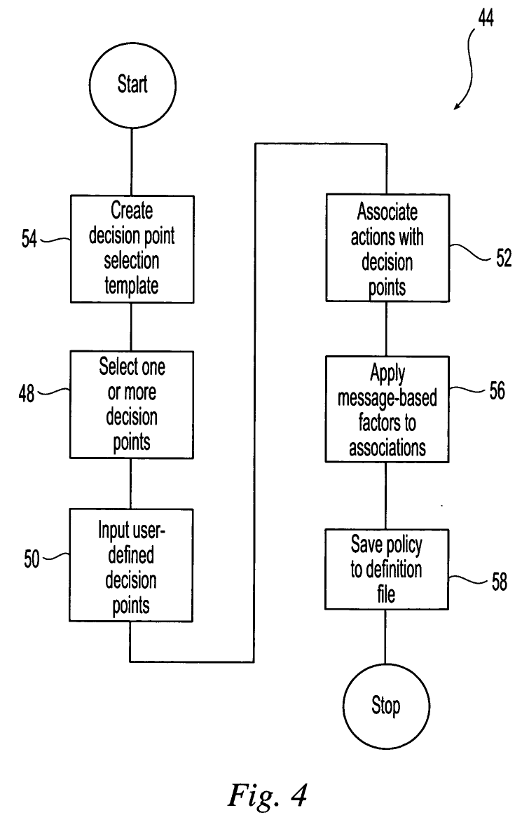

In one embodiment as illustrated in FIG. 4, in order to identify or to create a policy to be applied to the electronic message 44, one or more decision points are selected from a list of pre-defined decision points 48. Additional user-defined decision points can also be inputted 50 for inclusion in the identified policy. Each decision point defines a quality of the electronic message that can be evaluated. Suitable decision points, that can be stored in the pre-defined list of decision points for example, include verifying that the electronic message is signed, verifying that the electronic message is signed using a signature certificate issued by a trusted certificate authority, verifying that the first end entity owns the signature certificate, verifying that the signature certificate has not expired, verifying the signature certificate by verifying a certificate authority signature, verifying that a certificate revocation list to be used to verify the signature certificate is available and updated, verifying that the electronic message has not been modified after being sent by the first end entity, verifying a domain associated with the first end entity, verifying a domain associated with the second end entity, verifying that the electronic message is in the proper format and combinations thereof.

Associated with each decision point is one or more actions to be taken based upon the evaluation of the electronic message 52. Typical decision point actions include sending the electronic message to the second end entity, routing the electronic message to a third party, rejecting the electronic message, modifying the electronic message, notifying the first end entity regarding results of the policy evaluation, notifying the second end entity regarding the results of the policy evaluation, notifying the third party regarding the results of the policy evaluation, returning the electronic message to the first end entity and combinations thereof. The combination of a decision point and a decision point action constitutes a rule against which the electronic messages are evaluated. For example, the rule could be that if the electronic message was not signed using a valid signature certificate, the message is returned to the sender and the system administrator, i.e. a third party, is notified of the invalid signature certificate. In this example, the decision point is the evaluation of whether or not the message was signed using a valid certificate, and the decision point action is returning the message and notifying the administrator.

Therefore, a policy is constructed from one of more pairs of decision points and decision point actions. Once constructed, the policy can be saved to a policy definition file 58. These saved policies can then be easily accessed during message evaluation and can also be used in the future in the identification of a policy 44. In order to facilitate the selection of the decision points and the association of the decision points with appropriate actions, one or more decision point selection templates are created 54. These templates, however, are not necessary for the identification of policies.

In one embodiment, each identified policy can be applied to each electronic message regardless of any electronic message-based factors. These factors include, but are not limited to, the contents of the electronic message, the identity and domain of the sender and the identity and domain of the recipient. However, certain decision points may not apply to an electronic message containing certain message-based factors. For example, only messages going to a specific domain need to be signed. In addition, these message-based factors may dictate that different decision point actions apply depending on the outcome of the policy evaluation. Evaluating policies based upon message-based factors provides the benefit of a more efficient policy evaluation and the more efficient use of system resources, because resources and computation time are not used for policy evaluations that are not required.

Therefore, in another embodiment, electronic message-based factors are taken into account in the creation, selection, application or evaluation of each identified policy. As illustrated in FIG. 4, the message-based factors are taken into account during the association of actions with decision points. In another embodiment, the decision point templates can be used to assist in selecting decision points based upon electronic message content by constructing the decision point templates based upon electronic message-based factors.

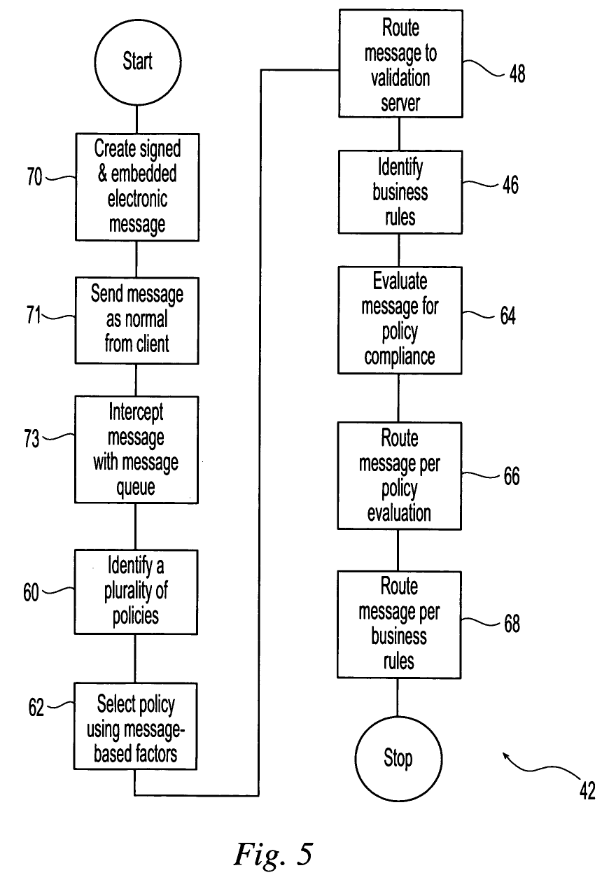

As is illustrated in FIG. 5, electronic message-based factors can be taken into account during the selection of a policy. In this embodiment, a plurality of policies capable of being applied to the electronic message are identified 60. The identification of each policy in the plurality of policies can be accomplished using the same procedures as described above and illustrated in FIG. 4 for the identification of a single policy. For example, for each policy, one or more decision points defined to evaluate a quality of the electronic message are selected, either from the list of pre-defined decision points or from user-inputted decision points, and one or more actions to be taken based upon the evaluation of the electronic message are associated with the decision points. Therefore, the identification of a plurality of policies is accomplished by iteratively identifying single policies based on varying factors until a sufficient number or variety of policies has been identified. In one embodiment, the plurality of polices contains a sufficient number and variety of policies to accommodate the variety of electronic messages to be evaluated. Once the plurality of policies is identified, one or more policies are selected for application to and evaluation of the electronic message or messages. Preferably as illustrated, the policies are selected for the plurality of identified policies using electronic message-based factors 62.

As is illustrated in FIGS. 3 and 5, in addition to defining suitable policies to be applied to the electronic messages, the method 42 of the present invention includes identifying at least one business rule 46 to be applied to the electronic messages. Business rules are typically not message content based or are not applied based upon electronic message-based factors. Instead, business rules reflect general business policies or software functions. Business rules handle routine business situations including user vacation notifications and lost or forgotten common access cards. In general, policies and business rules can be based on any attribute in the electronic message or on any PKI attribute. Alternatively, a determination can be made about whether a particular business rule applies to an electronic message using electronic message based factors. Again, using message-based factors in the application of business rules preserves system resources and expedites the evaluation process.

Once the policies and business rules have been identified, the electronic message is evaluated for compliance with the identified policy 64. Following policy evaluation, the electronic message is routed in accordance with the policy evaluation 66. The electronic message is also routed in accordance with any applicable business rules 68. The evaluation of whether or not the business rules apply is typically conducted during the identification of the business rule.

In one embodiment, in order to conduct the evaluation, each electronic message is routed to a certificate validation service contained on a validation server 48. In another embodiment, each electronic message is routed through a plurality of extensible policy verification servers. The plurality of servers can be arranged as a series of extensible policy verification servers, each having its own set of policies. Each message would pass sequentially through the servers. This type of arrangement illustrates a message passing through various domain levels en route to the recipient. Although a plurality of validation servers can be used, preferably, each electronic message is routed to a single, centralized validation server. The use of a centralized server provides for consistent, current, updatable and scalable application of policies.

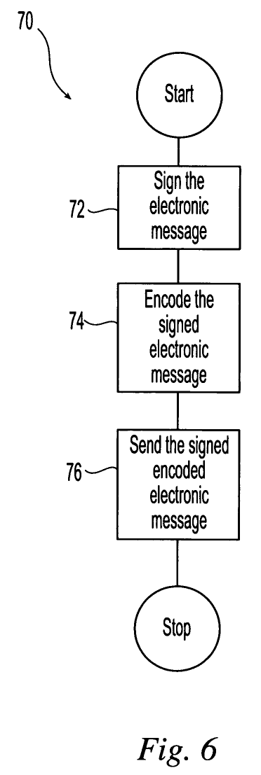

Using, for example, a PKI system, an electronic message is created, signed and encoded 70. As illustrated in FIG. 6, the electronic message is signed using a first end entity's private key 72 and is encoded using a second end entity's public key 74. The signed encoded message is then sent from the first end entity to the second end entity 76. As shown in FIGS. 3 and 5, in one embodiment the message can sent as normal 71 without checking policies or without checking business rules. Therefore, electronic messages that do not require processing can be forwarded without occupying system resources unnecessarily. In another embodiment, the electronic message is intercepted 73, for example by the message queue and routed through the validation server 48. In one embodiment, one decision point in the applicable policy is the evaluation of the signature certificate associate with the electronic message. Therefore, evaluation of the electronic message includes checking a certificate revocation list for the status of the signature certificate associated with the message. In addition, the evaluation process can differentiate between revocation codes for cause and revocation codes for administrative purposes. The validity period and authenticity of the CRL can also be checked, and the results of these checks can be used to determine the actions to be taken on the message.

A certificate can be current, valid and in good standing or revoked, expired, and limited in scope of authority. If the private key of a public-private key pair is revealed or lost, the public key is invalidated through certificate revocation. In the case of a lost server key, a new certificate can be issued to replace any cached certificate. If a root certificate authority (CA) looses or compromises its private key, all certificates signed by the CA would be invalid because the lost key was the basis of the signing certificate.

Certificate validation services in accordance with the present invention can work with any secure multipurpose internet mail extension (S/MIME) compliant electronic message, independent of software application or hardware platform. In addition, the certificate validation service can differentiate between messages created with web-based clients, for example Outlook Web Access (OWA) or mobile E-mail devices and between hardware and software certificates.

The routing of the electronic message in accordance with the policy evaluation and the business rule applies, for example, the decision point actions associated with the decision points in the policy. Examples of routing procedures include sending the electronic message to the second end entity, routing the electronic message to a third party, rejecting the electronic message, modifying the electronic message, notifying the first end entity regarding results of the policy evaluation, notifying the second end entity regarding the results of the policy evaluation, notifying the third party regarding the results of the policy evaluation, returning the electronic message to the first end entity and combinations thereof.

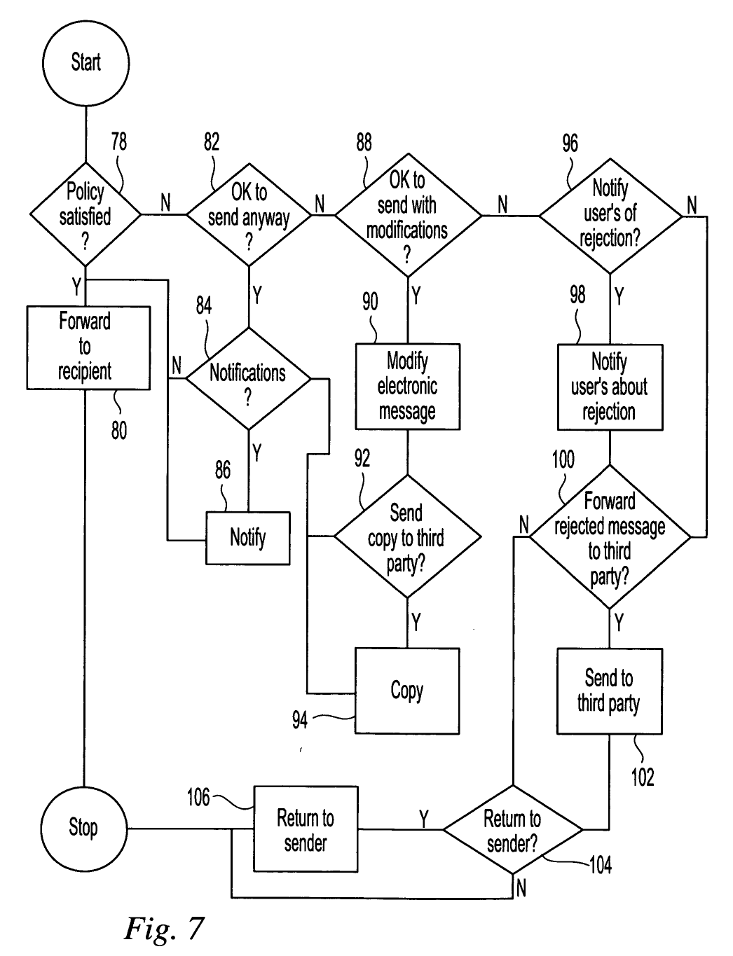

An illustration of an embodiment of policy evaluation and routing is shown in FIG. 7. This is an example only and many other arrangements of evaluations and routing are possible in accordance with the present invention. Initially, a determination of whether the electronic message complies with the policy is made 78. If the policy is satisfied, the message is forwarded to the recipient 80. If the policy is not satisfied, a determination is made of whether or not the message can be forwarded to the recipient regardless of policy failure 82. This determination could be based, for example, on which decision point within the policy that the message failed to satisfy. This step could also take into account message-based factors if these factors where not already considered in the formation of the policy.

If the message can still be forwarded to the intended recipient, a check is made as to whether or not the sender, recipient or a third party needs to be notified about the policy failure 84. If not, the message is delivered to the recipient 80. If notification is required, the appropriate parties are notified 86, and the message is delivered to the intended recipient 80. For example, the recipient could be provided with a notification that the attached message is associated with an out-dated signature certificate. If the message cannot be sent for failure to comply with prescribed policy, a determination is made about whether the message could be sufficient modified to be in policy compliance 88. If so, the message is modified 90, for example by removing sensitive material from the body of the message. A check is made about whether or not a third party, for example a system administrator, is to receive a copy of the modified message 92. If so, the copy is sent 94. If no copy is to be sent or following the sending the copy, an evaluation of notifications is made 84 and the message is processed as before.

If the message cannot be sent, even with modifications, then the message will be rejected and not delivered to the intended recipient. Preferably, the message will be intercepted and rejected before it even reaches the local server that provides for the electronic message functionality of the recipient. Once it has been determined that the message is to be rejected, a determination is made about whether or not the users, i.e. the sender or recipient are to be notified of the rejection 96. If so, then the users are notified with any appropriate explanation 98. Next a determination is made about whether or not to forward the failed massage to a third party 100. For example, if the message contains sensitive or secret information that is not authorized to be transmitted in an electronic message, then the message could be forwarded to a security administrator that polices the transfer of sensitive material. If appropriate, the message is forwarded to the third party 102. Finally, a determination is made about whether or not to return the contents of the original message to the sender 104. If so, then the contents are returned to the sender 106 and may even include an explanation as to why the message was not delivered, for example signature certificate failure.

The certificate validation method in accordance with the present invention utilizes a validation engine to facilitate verification of certificates and other user defined policies. The validation engine contains a wide variety of reliability and continuity capabilities. In general, the validation engine maintains current and up-to-date CRL's for all PKI's and automatically updates the CRL's as needed. The validation engine applies business rules independently to a CRL, providing the ability to customize the application of business rules. The validation engine provides the ability to time skew CRL data in case timely CRL's are not available from source directories. Although not required for proper operation, the validation engine can work with any Request for Comment (RFC) compliant on-line certificate status protocol (OCSP) responder. The policies or validation rules are easily created using a simple extensible mark-up language (XML), human readable format. The certificate validation service in accordance with the present invention can be implemented as a completely server based application without the need for any client-based software.

The present invention is also directed to a computer readable medium containing a computer executable code that when read by a computer causes the computer to perform a method for policy enforcement and verification of electronic messages in accordance with the present invention and to the computer executable code itself. The computer executable code can be stored on any suitable storage medium or database, including databases in communication with and accessible across the network 14, and executed on any suitable hardware platform as are known and available in the art.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of the present invention.

What is claimed is:

1. A method for policy verification in electronic messages, the method comprising:
identifying a policy to be applied to an electronic message sent from a first end entity to a second end entity;
identifying at least one business rule to be applied to the electronic message;
evaluating the electronic message for applicability with the identified policy; and
routing the electronic message in accordance with the policy evaluation and the business rule.

2. The method of claim 1, wherein the step of identifying a policy to be applied to an electronic message comprises:
selecting one or more decision points from a list of pre-defined decision points, each decision point defined to evaluate an attribute of the electronic message; and
associating with each decision point one or more actions to be taken based upon the evaluation of the electronic message.

3. The method of claim 2, wherein the list of pre-defined decision points comprises verifying that the electronic message is signed, verifying that the electronic message is signed using a signature certificate issued by a trusted certificate authority, verifying that the first end entity owns the signature certificate, verifying that the signature certificate has not expired, verifying the signature certificate by verifying a certificate authority signature, verifying that a certificate revocation list to be used to verify the signature certificate is available and updated, verifying that the electronic message has not been modified after being sent by the first end entity, verifying a domain associated with the first end entity, verifying a domain associated with the second end entity, verifying that the electronic message is in the proper format or combinations thereof.

4. The method of claim 2, wherein the decision point actions comprise sending the electronic message to the second end entity, routing the electronic message to a third party, rejecting the electronic message, modifying the electronic message, notifying the first end entity regarding results of the policy evaluation, notifying the second end entity regarding the results of the policy evaluation, notifying the third party regarding the results of the policy evaluation, returning the electronic message to the first end entity or combinations thereof.

5. The method of claim 2, further comprising:
creating one or more decision point selection templates to assist in selecting decision points based upon electronic message content; and
selecting the decision points using one of the templates.

6. The method of claim 2, wherein the step of identifying a policy to be applied to an electronic message further comprises inputting one or more user-defined decision points.

7. The method of claim 2, further comprising applying electronic message-based factors when associating the decision point actions with the decision points.

8. The method of claim 1, further comprising saving the identified policy to a policy definitions file.

9. The method of claim 1, wherein the step of identifying a policy further comprises identifying a plurality of policies capable of being applied to the electronic message; and
selecting at least one policy from the plurality of policies to be applied to the electronic message.

10. The method of claim 9, wherein the step of identifying a plurality of policies comprises:
selecting, for each policy, one or more decision points from a list of pre-defined decision points, each decision point defined to evaluate a quality of the electronic message; and
associating with each decision point one or more actions to be taken based upon the evaluation of the electronic message.

11. The method of claim 10, wherein the list of pre-defined decision points comprises verifying that the electronic message is signed, verifying that the electronic message is signed using a signature certificate issued by a trusted certificate authority, verifying that the first end entity owns the signature certificate, verifying that the signature certificate has not expired, verifying the signature certificate by verifying a certificate authority signature, verifying that a certificate revocation list to be used to verify the signature certificate is available and updated, verifying that the electronic message has not been modified after being sent by the first end entity, verifying a domain associated with the first end entity, verifying a domain associated with the second end entity, verifying that the electronic message is in the proper format or combinations thereof.

12. The method of claim 9, wherein the step of selecting at least one policy comprises using electronic message-based factors to select each policy.

13. The method of claim 1, wherein the step of identifying a policy comprises using electronic message-based factors to identify the policy.

14. The method of claim 1, further comprising determining if the business rule applies to the electronic message using electronic message-based factors.

15. The method of claim 1, wherein the step of evaluating the electronic message comprises:
checking a certificate revocation list; and
differentiating between revocation codes for cause and revocation codes for administrative purposes.

16. The method of claim 1, wherein the step of routing comprises sending the electronic message to the second end entity, routing the electronic message to a third party, rejecting the electronic message, modifying the electronic message, notifying the first end entity regarding results of the policy evaluation, notifying the second end entity regarding the results of the policy evaluation, notifying the third party regarding the results of the policy evaluation, returning the electronic message to the first end entity or combinations thereof.

17. The method of claim 1, further comprising:
signing the electronic message using a private key associated with the first end entity;
encoding the signed electronic message using a public key associated with the second end entity; and
sending the encoded, signed electronic message from the first end entity to the second end entity.

18. A system for enforcing policies and business rules in electronic messages exchanged across a network among a plurality of end entities, the system comprising at least one certificate verification server capable of intercepting the electronic messages and of evaluating those messages for compliance with pre-defined policies and business rules.

19. The system of claim 18, wherein the certificate verification server comprises a single, centralized server.

20. The system of claim 18, wherein the certificate validation server comprises an extensible policy verification server.

21. The system of claim 18, wherein the certificate verification server further comprises:
a policy engine capable of enforcing the policies and business rules;
a policy builder capable of building the policy engine; and
a policy engine definition file to store a complete definition of the policy engine.

22. The system of claim 21, wherein the policy engine comprises:
a plurality of simple policy nodes, each defining a specific policy test and resulting action; and
a plurality of macro policy nodes that define combinations of simple policy nodes.

23. The system of claim 21, wherein the certificate verification server further comprises:
a messaging queue to intercept incoming and outgoing electronic messages for evaluation by the policy engine; and
a scheduler to schedule the evaluation of electronic by the policy engine.

24. The system of claim 18, wherein the certificate verification server is in communication with one or more certificate revocation lists, the certificate revocation lists used to evaluate compliance with the pre-defined policies.

25. The system of claim 24, further comprising a plurality of policy engines, each policy engine associated with at least one certificate authority, each certificate authority comprising one or more of the certificate revocation lists.

26. A computer readable medium containing a computer executable code that when read by a computer causes the computer to perform a method for policy verification in electronic messages, the method comprising:
identifying a policy to be applied to an electronic message send from a first end entity to a second end entity;
identifying at least one business rule to be applied to the electronic message;
evaluating the electronic message for applicability with the identified policy; and
routing the electronic message in accordance with the policy evaluation and the applicable business rules.

27. The computer readable medium of claim 26, wherein the step of identifying a policy to be applied to an electronic message comprises:
selecting one or more decision points from a list of pre-defined decision points, each decision point defined to evaluate an attribute of the electronic message; and
associating with each decision point one or more actions to be taken based upon the evaluation of the electronic message.

28. The computer readable medium of claim 27, further comprising:
creating one or more decision point selection templates to assist in selecting decision points based upon electronic message content; and
selecting the decision points based using one of the templates.

29. The computer readable medium of claim 27, wherein the step of identifying a policy to be applied to an electronic message further comprises inputting one or more user-defined decision points.

30. The computer readable medium of claim 27, further comprising applying electronic message-based factors when associating the decision point actions with the decision points.

31. The computer readable medium of claim 26, further comprising saving the identified policy to a policy definitions file.

32. The computer readable medium of claim 26, further comprising determining if the business rule applies to the electronic message using electronic message-based factors.

33. The computer readable medium of claim 26, further comprising:
signing the electronic message using the first end entity's private key;
encoding the signed electronic message using the second end entity's public key; and
sending the encoded, signed electronic message from the first end entity to the second end entity.
